(19) United States
(12) Patent Application Publication
(10) Pub. No.: US 2002/0015548 A1
(43) Pub. Date: Feb. 7, 2002

(54) Versatile electro-optical polarization controller

(76) Inventor: Pisu Jiang, 3 Templars Close (GB)

Correspondence Address: W DOUGLAS CAROTHERS JR, COUNEL INTELLECTUAL PROPERTY, 80 ROSE ORCHARD WAY, SAN JOSE, CA, 95134

(21) Appl. No.: 09/775,162

(22) Filed: Jan. 31, 2001

(30) Foreign Application Priority Data
Feb. 1, 2000 (GB) 00 022274.9

(51) Int. Cl. G02B 6/27; G02B 6/26

(52) U.S. Cl. 385/11; 385/40

(57) ABSTRACT

A polarization device is disclosed that provides versatility in achieving a desired polarization state of an optical signal. Current polarization controllers are provided with two or three control sections to induce λ/4 or λ/2 changes in the received optical signal. However, once designed, those controller have a fixed polarization mode of operation. The electro-optical polarization controller disclosed comprises a lithium niobate substrate having an optical waveguide for propagation of an optical signal with separate first, second, third and fourth control sections sequentially formed in cascaded fashion along the length of the waveguide. Each control section is provided with driver electrodes arranged to be driven with suitable electrical control signals to induce electro-optical birefringence in the waveguide along its respective control section length of the optical waveguide. More than four sections can be utilized in cascade along the waveguide to achieve better birefringence control of the optical signal.

### CROSS REFERENCE TO RELATED APPLICATION

This application claims priority and all other benefits under

35 U.S.C. §119 of prior filed co-pending British patent application No. 00 022274.9, filed Feb. 1, 2000, entitled, ELECTRO-OPTICAL POLARIZATION CONTROLLER and is incorporated herein by reference thereto.

### FIELD OF THE INVENTION

The present invention relates to an electro-optical polarization controller and methods of using such a polarization controller as well as an optical system employing such a controller, such as an optical telecommunication system.

### BACKGROUND OF THE INVENTION

There are several problems associated with the transmission of data at high data rates over long-distances using optical signals which are propagated along optical fibers. Regimes for the compensation of loss and dispersion are well known, but a remaining obstacle to high-data rate long-distance data transmission is polarization mode dispersion (PMD), where the polarization of the transmitted signal varies in a random manner, caused primarily by fibre birefringence.

In an attempt to address the problem of PMD, it is known to deploy in a receiver a polarization controller that is able to control dynamically the polarization state of a received optical signal. See, for example, Nigel G. Walker et al., Journal of Lightwave Technology, Vol. 8(3), pp. 438-457, 1990 and U.S. Pat. No. 5,212,743. In the embodiment of such a controller, the polarization state of a received optical signal is monitored and the polarization controller is appropriately driven to restore the polarization state of the received signal to a required state downstream of the controller.

A known form of such a polarization controller has an optical waveguide formed in a lithium niobate substrate. Suitable electrode structures or sets of electrodes are provided on the surface of the substrate in the vicinity of the waveguide so that driving the electrodes with suitable electrical control signals adjusts the optical birefringence of the waveguide. In this way, the polarization state of the optical signal may be restored dynamically to a required state. Notionally, such a controller having a single control section with three electrodes can function to transfer any state of polarization to any other state of polarization. However, if periodic resetting of the controller is to be eliminated (so-called endless control), then it has been established that two or three control sections are required, arranged serially or in cascade along the length of the optical waveguide.

In one known form of polarization controller of the kind described above, two separate control sections, each having individual electrodes, are provided in cascade along the length of the waveguide, and each is driven separately. In an alternative configuration, three such sections are provided serially along the length of the waveguide and again each section can be driven separately. In the case of a three section controller, the first and third sections may each be substantially a one quarter waveplate (QWP) element (at the intended frequency of operation) and the intermediate second section is substantially a one half waveplate (HWP) element. Then, the first and third sections can be driven synchronously and the second section is driven independently to obtain the required functionality. See, for example, the article of F. Heisman et al., Electronics Letters, Vol. 27(4), pp. 377-379, Feb. 14, 1991 as well as the above mentioned U.S. patent.

Although both of the above designs are able to operate very effectively, neither design has clear advantages over the other, for all circumstances of operation. Sometimes it may be better to use one of the designs or types, whereas in other circumstances it may be better to use the other controller design or type. However, once a receiver has been constructed to implement one type of polarization controller, it is very difficult to change the controller configuration to implement another type of polarization controller.

Thus, it is an object of this invention to provide a polarization controller that is more universal in its application.

It is a further object of this invention to provide a single polarization controller that can be re-configured into different wave plate geometries to perform different polarization modes of operation on a propagating optical signal.

### SUMMARY OF THE INVENTION

According to one aspect of this invention, there is provided a versatile electro-optical polarization controller to restore or otherwise change the polarization state of an optical signal comprises a lithium niobate substrate having an optical waveguide for propagation of an optical signal with separate first, second, third and fourth control sections sequentially formed in cascaded fashion along the length of the waveguide. Each control section is provided with driver electrodes arranged to be driven with suitable electrical control signals to induce electro-optical birefringence in the waveguide along its respective control section length of the optical waveguide. More than four sections can be utilized in cascade along the waveguide to achieve better birefringence control of the optical signal. Thus, the more the control sections, the better the control performance with an upper limit as a compromise of device cost versus the additional performance realized.

A package is provided to contain a chip comprising a polarization device that includes the lithium niobate substrate and respective individual electrical connections for the driver electrodes of each section to extend separately out of the package. Alternatively, a wafer may be employed that includes a plurality of polarization devices on the same substrate to preform multiple signal corrections. The plurality of polarization control sections can be independently operated and/or interconnected externally of the package to give a required control characteristic to the polarization state of the waveguide through varying the orientation of the linear birefringence of the waveguide. The polarization state can be varied among the several control sections in a predetermined manner such that each section is substantially a one quarter wave plate element at the intended operational frequency of the controller.

Advantageously, embodiments of this invention permit reconfiguring of a polarization controller constructed as a single, integrated optical device, so that the controller may be used either as a two section polarization controller or as a three section polarization controller.

It will be appreciated that the polarization controller of this invention has four sections arranged serially or in cascaded fashion along the length of the optical waveguide. Each section may be substantially of one quarter waveplate design, at the intended frequency of operation. The control electrodes of each section are led out of the package so as to be externally accessible. In this manner, once manufacture of the controller has been completed, it can be used as a four section controller, with appropriate drive signals supplied to each control section. Alternatively, by appropriate interconnection of the external terminals of the electrodes or matching the drive signals of selected electrodes, the controller may serve as a two section device or as a three section device as previously indicated.

The electro-optical polarization controller if this invention is utilized in optical systems for signal correction. For example, the present invention has utility in optical telecommunication systems for controlling the polarization state of optical data signals received in such systems. Such controllers can be employed in other optical systems to change the polarization state of an optical signal.

One embodiment can be realized in which the offset angle between the waveguide and the z-axis of the LiNbO₃ can be arranged, preferably optimized, to achieve a nominal tuning voltage, Vₜᵤₙₑ, of zero. Further embodiments can be realized that have a positive offset angle which reduces the drive voltage for mode conversion and increases the drive voltage for phase shift and, visa versa, for a negative offset angle.

One method of controlling the operation of the polarization controller of this invention is to provide a change in polarization state of an optical signal propagating along the length of the optical waveguide. The problems associated with polarization mode dispersion (PMD) in an optical fiber for high data rates in optical telecommunication systems are well known in the art. Polarization controllers are employed to restore the polarization state of an optical signal received in a receiver in such systems. A method of this invention comprises the first and fourth control sections of the device separately driven by first and second suitable control signals or synchronously driven by a single, suitable control signal, and the corresponding electrodes of the second and third control sections are linked together externally of the package and are driven by a third common drive signal.

Another method of controlling the operation of the polarization controller of this invention comprises the corresponding electrodes of the first and second control sections being linked together externally of the package and driven by a first common drive signal, and the corresponding electrodes of the third and fourth control sections being linked together externally of the package and driven by a second common drive signal.

Preferably, each control section of the polarization controller has two associated driver electrodes and a ground electrode. Each of these electrodes extend along the waveguide for a length sufficient to form a one-quarter waveplate element at the intended operating frequency of the controller. Such electrodes should be configured with a central ground electrode and the pair of driver electrodes arranged, one to each side of the central ground electrode. In this case, the central ground electrode of each section may extend along the waveguide.

The connections to the driver electrodes of each section are separately brought out of the package to give external access to those electrodes to permit the configuration or driving of the controller as described above. The ground electrode of each section may also be terminated externally of the package to provide separate access to each ground electrode. In an alternative embodiment, the ground electrodes of each section may be connected internally of the package to avoid the need for separate terminations for each ground electrode external of the package. In a further embodiment a single ground electrode may be provided, extending along the length of the waveguide and through each of the four control sections.

The various features of the present invention and its preferred embodiments may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF THE DRAWINGS

FIG. 1 diagrammatically illustrates a first embodiment of a polarization controller comprising this invention.

FIG. 2 shows the polarization controller connected in a first configuration of the invention.

FIG. 3 shows the polarization controller connected in a second configuration of the invention.

FIGS. 4A, 4B and 4C are graphic illustrations of polarization Poincare sphere coverage to illustrate the improved coverage in the case of the multi-control sectioned polarization controller of this invention.

### DETAILED DESCRIPTION OF THE INVENTION

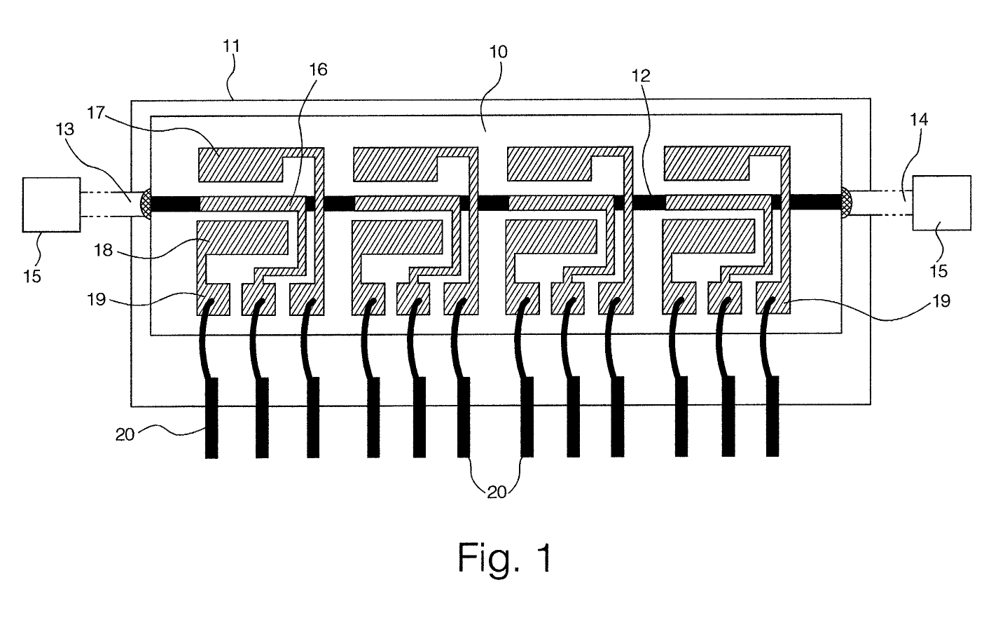

FIG. 1 diagrammatically illustrates an integrated optical device comprising a polarization controller 10 of this invention. The device comprises a lithium niobate substrate 10A which is mounted within a metallic package 11. Subsequent to manufacture, the package may be hermetically sealed to protect substrate 10A from the ambient environment. An optical waveguide 12 extends linearly through the substrate 10A, the waveguide being formed in a well known manner, by doping the lithium niobate, for example, with titanium. Pigtails 13 and 14, each comprising a short length of optical fiber, are secured to the end faces of substrate 10A in optical alignment with waveguide 12 and are led out of the package. Each pigtail terminates in a respective connector 15. Pigtails 13, 14 permit light, in the form of an optical signal, to be fed into waveguide 12 at the input end of the device and to exit from waveguide 12 from the output end of the device.

Electrode structures are formed on the upper surface of the substrate. It can be seen in FIG. 1 that there are four separate sets of electrodes 31, 32, 33, 34 arranged serially or in cascade along the length of waveguide 12 formed in substrate 10A. Each of these electrode sets comprises a separate and independently control section of polarization controller 10. Each electrode set 31-34 comprises a central ground electrode 16 positioned immediately above or overlying a portion of the waveguide 12, and to each side of that central ground electrode, there is a pair of driver electrodes 17, 18. The three electrodes 16, 17, 18 of each electrode set 31-34 extend substantially parallel to one another along the length of waveguide 12. A buffer layer (not shown) typically is provided between each electrode and the surface of the substrate to isolate the electrodes 16-18 from waveguide 12.

On the surface of substrate 10A, each electrode is connected to a respective termination pad 19, which is connected by means of a flying connect wire 25 to a respective pin 20 projecting from the package 11. Thus, an electrical connection may be made externally of the package to each individual electrode 16, 17 or 18 formed on substrate 10A.

Each set of electrodes 16, 17 or 18 forms one control section 21, 22, 23 or 24 of the device and can independently function as a one quarter waveplate (QWP) element. By applying a suitable drive signal to electrode set 16-18 of any one control section, that section serves to vary the orientation of linear birefringence of waveguide 12 in that section to change the state of polarization of the optical signal propagating through that section along waveguide 12, which phenomena and function is known in the art.

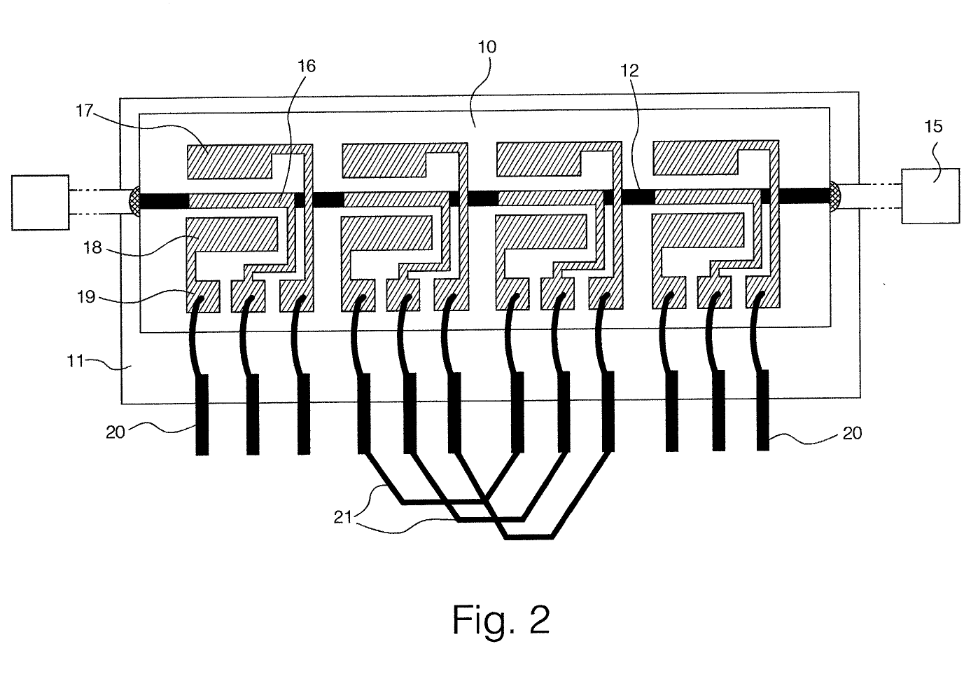

FIG. 2 shows one possible electrical-connect configuration for the plurality of control sections 31-34 of polarization controller 10 in FIG. 1. In the case here, the two central control sections 32, 33 have their respective electrodes 16-18 linked externally by conductors 21 between the respective pins 20 of the two control sections. Thus the two central control sections 32, 33 together form a one half waveplate (HWP) element at the intended frequency of operation while the two outer sections 31, 34 function as separate quarter waveplate (HWP) elements. In this manner, the entire polarization controller may serve as a QWP+HWP+QWP device, with the QWP first and fourth control sections 31, 34 being driven synchronously by first driver signals and the second and third control sections 32, 33 being driven simultaneously by the same, second driver signals.

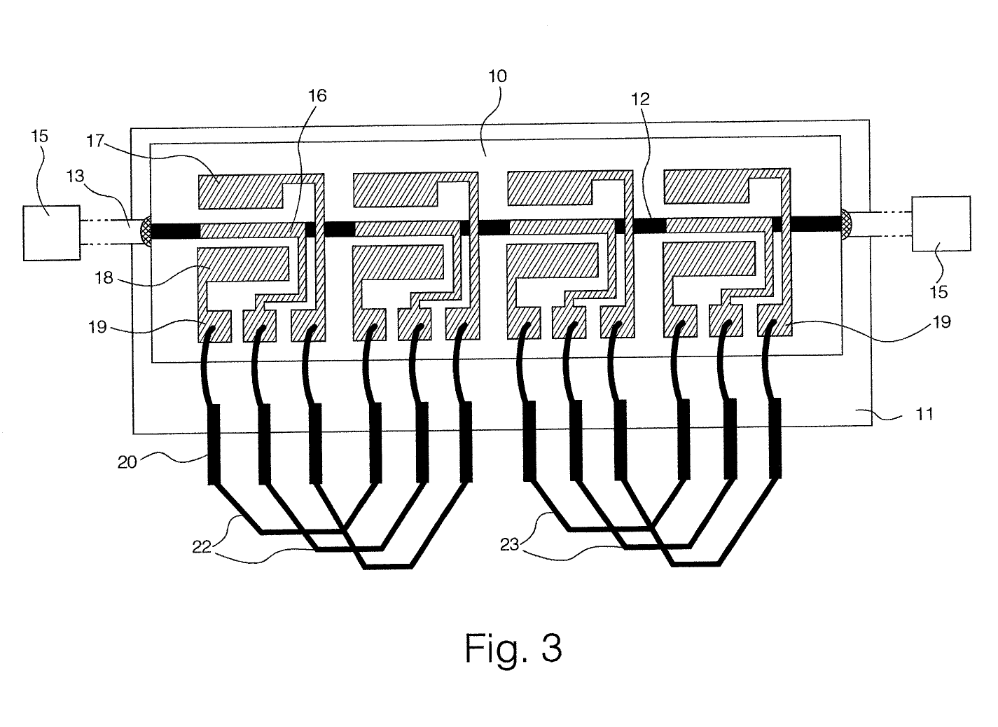

FIG. 3 shows another electrical-connect configuration for the plurality of control sections 31-34 of polarization controller 10 in FIG. 1. In FIG. 3, the first and second control sections 31, 32 have their electrodes 16-18 linked together by means of external conductors 22 connected to respective pins 20 of these two sections. Similarly, the third and fourth control sections 33, 34 have their electrodes linked together by means of external conductors 23 connected to respective pins 20 of those two sections. In this manner, the overall polarization controller may serve as a two section device, with the first and second control sections 31, 32 being driven simultaneously by a first driver signal and the third and fourth control sections 33, 34 being driven simultaneously by a second driver signal.

It will be appreciated that at the time of manufacture, the embodiments are not committed to being a two section device, three section device or a four section device. Rather subsequent to manufacture of the device and only at the time the device is to be incorporated into a receiver is the device committed to being functionally of one kind of operation or another, thereby leading to considerable economies, and removing the need to separately manufacture different devices dependent upon the kind of polarization control that is desired to be deployed.

A further advantage arising from the polarization controller arranged as a series of four sections, such as compared to the known constructions of having either two sections in series or three sections in series, is that an improvement in performance can be expected. Due to the limits on processing tolerances, an integrated device cannot be ideal. For example, the alignment between the waveguide and the electrodes will be less than perfect due to these tolerances. This can be compensated to some extent by adjusting various parameters, such as, for examples, the compensation voltage to compensate for offset angle variation and electrode-waveguide misalignment. It will be appreciated that compensation for offset angle variation involves increasing the compensation voltage as the offset angle increases and visa versa. Furthermore, dividing the electrodes into increasingly smaller sections allows the compensation voltage to be more closely matched to a respective section of waveguide misalignment which will improve the operation of the device. Since the non-ideal real configuration may vary along the length of a section, ideally one should apply a varying compensation voltage along the length of that section, to ensure it operates with the improved performance. Unfortunately, this is not possible, and in practice one must apply a constant correction to the whole length of the section. The probability is that for much of the length of the section, the wrong correction is applied.

By dividing the length of a control section into several smaller sub-sections, and applying the appropriate correction individually to each sub-section, a greater part of the combined whole section can be operated nearer to an ideal condition. Consequently, the division of a section into several smaller sub-sections and simultaneously applying optimal correcting parameters for each sub-section should lead to an improved overall performance. Ideally, a device should be divided into a number of control sections such that each section is small enough so that waveguide misalignment can be easily compensated. However, while the addition of smaller control sections along the waveguide will improve overall performance, it adds complexity to its operation and control. Thus, the dividing a half wave plate into two quarter waveplates adds one more section with improved performance. The dividing of all four half wave plates into eight smaller one-eight wave plates would provided even more improved performance, but it may not be as practical from a cost standpoint. However, depending upon the application, it may be still desired where demands for higher performance are required.

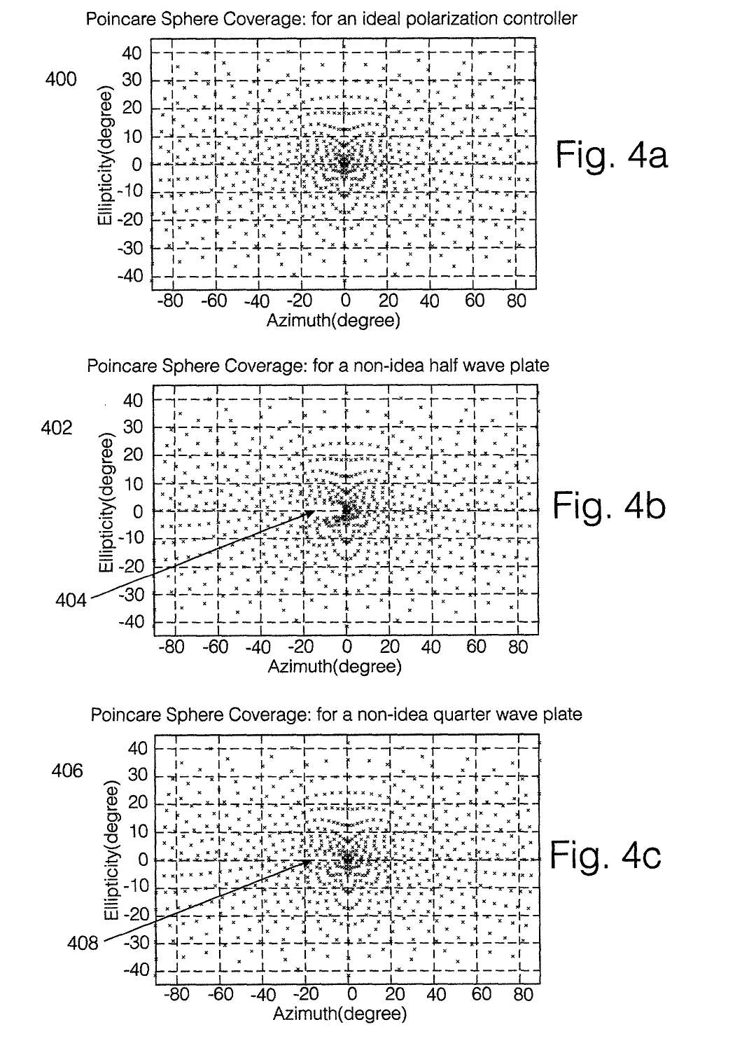

Referring to FIG. 4A, there is shown a 2-dimensional plot of the Poincare sphere coverage for an ideal polarization controller. The results were obtained by modeling such that a known and fixed polarization state of an optical signal was input to the device and the drive voltage was varied to produce all possible, or at least a subset of all possible, output polarization states. It can be appreciated from the plot of FIG. 4A that the ideal polarization controller can convert any input polarization state to any of the possible output states.

However, it can also be appreciated that the same cannot be said for a non-ideal half-wavelength polarization controller as can be seen from FIG. 4B. FIG. 4B illustrates a Poincare sphere plot for a non-ideal half wavelength plate having a fixed degree of skew and a half-wavelength plate. It can be seen that the non-ideal half-wavelength plate polarization controller there is region 404 representing polarization states to which the controller cannot convert the input optical signal. It can be appreciated from FIG. 4C, which shows a Poincare sphere plot 406 for a non-ideal quarter-wavelength plate, which has the same degree of skew as for FIG. 4B, that region 408 of non-coverage is reduced in size relative to that of region 404 of the half-wavelength plate shown in the plot of FIG. 4B. Therefore, it can be appreciated that the smaller the length of the electrodes used in a polarization controller, the greater the degree of control that can be exerted over the output signal polarization states. However, this greater degree of control requires more complex management of the drive signals that are applied to the signal electrode sets of the various cascaded control sections of the controller.

As a consequence, a single manufactured device can serve as either known form of polarization controller with greater economies being possible in view of the need to make only one device in larger quantities. Further, it is easier to manufacture the device to closer tolerances in order to give improved performances during its operation.

To deploy the device of this invention in a receiver, it is preferable to provide a monitor for determining the polarization of the received or transmitted optical signal. Such monitoring is preferably performed downstream of the device and is dynamically compared with the required polarization state. Drive signal amplifiers, connected to the various electrodes of the device, are then controlled to dynamically control the polarization state of the optical signal exiting the device, based upon the monitored state, so as to set that state to the required polarization mode. The monitoring of the polarization state and the controlling of drive signal amplifiers will not be described in further detail here.

Although the invention has been described in conjunction with one or more preferred embodiments, it will be apparent to those skilled in the art that other alternatives, variations and modifications will be apparent in light of the foregoing description as being within the spirit and scope of the invention. Although the above embodiments have been described in terms of realizing a λ/4,λ/2,λ/4, and a λ/2,λ/2 wavelength plates, it will be appreciated that the embodiments can also be realized in which any combination of the four λ/4 wavelength plates is used to control the polarization. For example, the first and third electrode sets may be driven separately from the second and fourth electrode sets. Furthermore, it can be appreciated that the drive voltages applied to the electrode sets may be arranged in any combination, for example, the first electrode set may be driven synchronously with the second, third, fourth electrode sets or any combination thereof. The same applies to the remaining electrodes. Thus, the invention described herein is intended to embrace all such alternatives, variations and modifications as that are within the spirit and scope of the following claims.

What is claimed is:

1. A polarization controller for an optical signal, comprising:
a substrate having an optical waveguide formed along a length of the substrate along which the optical signal propagates;
a plurality of control sections arranged in cascade along the waveguide relative to a predetermined length of the waveguide;
each control section being provided with a set of a plurality of control electrodes arranged, when driven with suitable electrical control signals, to induce a change in electro-optical birefringence in the waveguide along a length of the waveguide encompassed by a respective control section; and
a plurality of electrical connections for each control electrode set of each control section, at least one of said control section electrode sets being interconnected to a selected other control set of at least one other control section to provide a given control characteristic to the controller.

2. The polarization controller according to claim 1 wherein the given control characteristic is a change in the polarization state of the optical signal.

3. The polarization controller of claim 1 wherein the control sections along the waveguide between the first and last control sections are interconnected.

4. The polarization controller of claim 1 wherein the first and last control sections along the waveguide are interconnected and the control sections therebetween are interconnected.

5. The polarization controller according to claim 1 wherein the control electrodes of each control section are aligned parallel with a longitudinal axis of the waveguide.

6. The polarization controller of claim 1 wherein said substrate is provided in a package; said control electrode set of each control section being separately bought out of the package so that the respective control sections may be interconnected externally of the package in a manner to provide a given control characteristic to the controller.

8. The polarization controller of claim 7 wherein the control sections along the waveguide between the first and last control sections are interconnected.

9. The polarization controller of claim 7 wherein the first and last control sections along the waveguide are interconnected and the control sections therebetween are interconnected.

10. The polarization controller of claim 9 wherein said package is hermetically sealed.

11. The polarization controller according to claim 9 wherein the given control characteristic is a change in the polarization state of the optical signal.

12. The polarization controller according to claim 1 wherein each control section is substantially a one quarter waveplate (QWP) element at an intended frequency of operation of the controller.

13. The polarization controller according to claim 1 said control electrodes in each control section comprises a plurality of driver electrodes and a ground electrode, each electrode in an electrode set extending along and parallel with the waveguide for the predetermined waveguide length.

14. The polarization controller according to claim 13 wherein three electrodes in each electrode set are associated with each control section comprising a central ground electrode overlying a predetermined waveguide length of a control section and a pair of drive electrodes positioned on adjacent sides of the waveguide for the predetermined waveguide length of a control section.

15. The polarization controller as claimed according to claim 13 wherein a common ground electrode extends through all of said control sections.

16. The polarization controller according to claim 13 wherein the ground electrodes of the control sections are electrically coupled together internally of a package in which the substrate is packaged.

17. The polarization controller according to claim 1 as employed in an optical system.

18. The polarization controller according to claim 17 wherein an optical telecommunication system comprises said optical system.

19. An optical telecommunication system comprising a polarization controller as set forth in claim 1.

20. The optical telecommunication system of claim 19 wherein said controller is in a receiver of said system.

21. A method of using a polarization controller having a plurality of control sections in a package with each section including an electrode set of at least one drive electrode and one ground electrode to which control signals are applied, comprising the steps of:
separately driving the electrode sets of the first and last control sections with first and second drive signals, and
synchronously driving the electrode sets of intermediate control sections between the first and last control sections with a common third drive signal.

22. The method as claimed in claim 21 in which the electrode sets of the intermediate control sections are linked together externally of the package.

23. The method as claimed in claim 21 in which the electrode sets of first and last control sections are driven synchronously with the first drive signal.

24. A method of using a polarization controller having a plurality of control sections in a package with each section including an electrode set of at least one drive electrode and one ground electrode to which control signals are applied, comprising the steps of:
synchronously driving the electrode sets of the first control section and one intermediate control section with a first drive signal, and
synchronously driving the electrode sets the last control section and another intermediate section with a second drive signal.

25. A method as claimed in claim 24 in which the electrode sets of the first and one intermediate control sections are linked together externally of the package.

26. A method as claimed in claim 24 in which the electrode sets of the last and another intermediate control sections are linked together externally of the package.
